(19) United States
(12) Patent Application Publication
(10) Pub. No.: US 2026/0138137 A1
(43) Pub. Date: May 21, 2026

(54) PIPETTING NEEDLE INNER/OUTER WALL CLEANING MECHANISM AND PIPETTING NEEDLE ASSEMBLY

(71) Applicant: CHEMLEX PTE. LTD., SINGAPORE (SG)

(72) Inventors: Xiangxiang LI, SINGAPORE (SG); Chao LU, SINGAPORE (SG); Yanqing YU, SINGAPORE (SG)

(73) Assignee: CHEMLEX PTE. LTD., SINGAPORE (SG)

(21) Appl. No.: 18/954,553

(22) Filed: Nov. 21, 2024

(51) Int. Cl. B01L 3/02; B08B 9/023; B08B 9/032

(52) U.S. Cl. CPC B01L 13/02; B01L 3/021; B08B 9/023; B08B 9/0321; B01L 2200/028; B01L 2200/0689; B01L 2200/141; B01L 2300/0663; B08B 2209/032

(57) ABSTRACT

The invention discloses an inner/outer wall cleaning mechanism for a pipetting needle and a pipetting needle assembly, which comprises: an inner wall cleaning pipe; which is connected at one end to the upper part of the pipetting needle and the other end of which is connected to the injection device; an outer wall cleaning pipe; which is connected at one end to the liquid guide and the other end of which is connected to the injection device; the liquid guide; liquid inlets arranged on both sides, a liquid outlet and an outer wall cleaning flow passage hole arranged in the liquid guide, one end of the liquid inlet being connected to the outer wall cleaning pipe, the other end of the liquid inlet being connected to one end of the liquid outlet, and the other end of the liquid outlet being connected to the outer wall cleaning flow passage hole.

### FIELD

The present disclosure relates to the field of automated laboratory sampling technology, and in particular to an inner/outer wall cleaning mechanism for a pipetting needle and a pipetting needle assembly.

### BACKGROUND OF THE DISCLOSURE

In the field of medicinal synthesis, pipetting needles come into contact with different solutions when performing liquid handling operations such as pipetting, which can lead to cross-contamination of the different solutions. To ensure that the experiment is free from contamination, pipetting needles need to be washed before changing the solution.

Common pipetting needle cleaning mechanisms that wash the inner/outer walls include the fountain and waterfall types. The fountain type requires an external cleaning container, and the cleaning solution is sprayed from bottom to top to carry out the cleaning operation. This type of device has a low degree of integration, takes up a lot of space, is prone to cross-contamination and a large demand for cleaning liquid; the waterfall type sprays the cleaning liquid from top to bottom, but the pressure is not enough to effectively clean the pipetting needle, and the pipetting needle cleaned in the above way is prone to liquid retention, which can easily drip during pipetting operations and cause pollution.

Therefore, there is an urgent need for a pipetting needle cleaning structure that ensures that the cleaning solution has sufficient pressure, adequately cleans the needle, avoids cross-contamination, and improves device integration.

### BRIEF SUMMARY OF THE DISCLOSURE

The present disclosure seeks to solve the technical problem of high probability of cross-contamination during cleaning of the inner/outer wall of a pipetting needle, low cleaning efficiency of the pipetting needle, and poor cleaning effect. To solve the technical problem, the present disclosure provides an inner/outer wall cleaning mechanism of a pipetting needle and a pipetting needle assembly.

On the one hand, the present disclosure provides an inner/outer wall cleaning mechanism for a pipetting needle, the inner/outer wall cleaning mechanism for cleaning the pipetting needle comprising:
an inner wall cleaning pipe; the inner wall cleaning pipe is connected at one end to the upper part of the pipetting needle and at the other end to an injection device;
an outer wall cleaning pipe; the outer wall cleaning pipe is connected at one end to a liquid guide and at the other end to the injection device;
the liquid guide; liquid inlets are arranged on both sides of the liquid guide, a liquid outlet and an outer wall cleaning passageway hole are arranged in the liquid guide, one end of the liquid inlet is connected to the outer wall cleaning pipe at one end, the other end of the liquid inlet is connected to the end of the liquid outlet, and the other end of the liquid outlet is connected to the outer wall cleaning passageway hole.

In some possible embodiments, the diameter of the liquid outlet is smaller than the diameter of the liquid inlet.

In some possible embodiments, the outer wall cleaning pipe is connected to the injection device via a pipe connector, the pipe connector comprising at least a liquid inlet pipe opening and a cleaning pipe opening, the liquid inlet pipe opening being connected to the injection device, and the cleaning pipe opening being connected to the outer wall cleaning pipe.

In some possible embodiments, the outer wall cleaning pipe comprises a first connection opening, a second connection opening and a third connection opening, the first connection opening being connected to a liquid inlet on one side of the liquid guide, the second connection opening being connected to a liquid inlet on the other side of the liquid guide, and the third connection opening being connected to the cleaning pipe opening.

In some possible embodiments, the cleaning pipe opening comprises a first pipe opening and a second pipe opening, the outer wall cleaning pipe comprising:
a first outer wall cleaning pipe, which is connected at one end to the liquid inlet on the side of the liquid guide;
a second outer wall cleaning pipe, which is connected at one end to the liquid inlet on the other side of the liquid guide;
the other end of the first outer wall cleaning pipe is connected to the first pipe opening and the other end of the second outer wall cleaning pipe is connected to the second pipe opening.

In some possible embodiments, the inner/outer wall cleaning mechanism further comprises a first pipe joint, a second pipe joint and a pipe joint connecting plate, one end of the first pipe joint being connected to one end of the inner wall cleaning pipe, the first pipe joint and the second pipe joint are fixedly connected via the pipe joint connecting plate, a channel is formed between the first pipe joint and the second pipe joint, and one end of the second pipe joint is connected to the upper part of the pipetting needle.

In some possible embodiments, the inner/outer wall cleaning mechanism further comprises a third pipe joint, a fourth pipe joint, a fifth pipe joint and a sixth pipe joint, the third pipe joint being connected to the first outer wall cleaning pipe and the first pipe opening, the fourth pipe joint being connected to the second outer wall cleaning pipe and the second pipe opening, the fifth pipe joint is connected to the first outer wall cleaning pipe and the liquid inlet on one side of the liquid guide, and the sixth pipe joint is connected to the second outer wall cleaning pipe and the liquid inlet on the other side of the liquid guide.

In some possible embodiments, the inner/outer wall cleaning mechanism further comprises a fixing member which is arranged on the outer wall of the pipetting needle and which is connected and fixed to the upper surface of the liquid guide, the upper surface being the surface of the liquid guide in contact with the fixing member.

In some possible embodiments, the inner/outer wall cleaning mechanism further comprises a sealing member, the sealing member being provided on a grooved surface of the liquid guide; wherein the grooved surface is obtained by grooving the upper surface of the liquid guide, the upper surface being the upper surface of the liquid guide being close to the pipetting needle surface of the top of the needle barrel.

In some possible embodiments, the other end of the inner wall cleaning pipe and the other end of the outer wall cleaning pipe are each connected to the injection device, or the other end of the inner wall cleaning pipe and the other end of the outer wall cleaning pipe are each connected to different injection devices.

On the other hand, the present disclosure also provides a pipetting needle assembly having an inner/outer wall cleaning mechanism for a pipetting needle, the pipetting needle assembly comprises a sliding structure, a mobile module, a connecting structure and the inner/outer wall cleaning mechanism, the inner/outer wall cleaning mechanism being fixedly connected to the connecting structure, and the connecting structure being slidably connected to the mobile module via the sliding structure.

In some possible embodiments, the mobile module is provided with a first sensor and a second sensor, the connecting structure is provided with a positioning sensor, and the positioning sensor is slidably arranged between the first sensor and the second sensor via the connecting structure.

By adopting the above technical solution, the present disclosure provides a cleaning mechanism for the inner/outer wall of a pipetting needle and a pipetting needle assembly with the following beneficial effects:
(1) The present disclosure provides an inner/outer wall cleaning mechanism for a pipette needle that cleans the inner wall of the pipette needle through an inner wall cleaning pipe and cleans the outer wall of the pipette needle through an outer wall cleaning pipe, thereby realizing comprehensive cleaning of the inner/outer wall of the pipette needle, and is capable of cleaning the outer wall of the pipette needle from a plurality of angles by providing a liquid inlet on both sides of the liquid guide, optimizing the cleaning effect of the pipette needle by connecting the outlet opening to the middle of the outer wall cleaning passageway hole. The flow rate and pressure of the cleaning liquid are increased, further enhancing the cleaning strength of the outer wall. Cleaning the pipetting needle by means of the inner/outer wall cleaning mechanism saves manpower, reduces the dependence on manual operation and the requirement for precision of manual operation, reduces the probability of cross-contamination of the pipetting needle, shortens the time interval for replacing the pipetting needle with a solution, and improves the productivity of the laboratory.
(2) The present disclosure provides a pipetting needle assembly, which can conveniently clean the inner/outer wall of the pipetting needle, realizing the special washing of the special needle, saving labor cost, thus shortening the interval time between the pipetting needle being put into production use and improving the cleaning efficiency, and improving the degree of utility and production efficiency by moving the pipetting needle assembly up and down along with the mobile module, so as to enable the pipetting needle to be moved to a specific location according to the need for realizing the cooperation with other automated link experimental devices. The pipette assembly moves up and down with the moving module, enabling the pipette to move to specific positions as needed to work with other automated lab equipment, improving automation and productivity.

### BRIEF DESCRIPTION OF THE DRAWINGS

In order to more clearly describe the technical solutions in the present disclosures, the accompanying drawings to be used in the description of embodiments will be briefly introduced below, and it will be obvious that the accompanying drawings in the following description are only some of the embodiments of the present application, and that for those skilled in the art, other drawings can be obtained based on these drawings without putting in creative labor.

FIG. 1 is a structural schematic diagram of an inner/outer wall cleaning mechanism of a pipetting needle provided by an embodiment of the disclosure;

FIG. 2 is a schematic diagram of a structure of a liquid guide structure provided by an embodiment of the disclosure;

FIG. 3 is a schematic diagram of a connection relationship of an outer wall cleaning pipe provided by an embodiment of the disclosure;

FIG. 4 is a schematic diagram of the structure of a pipetting needle assembly provided by an embodiment of the disclosure.

### DETAILED DESCRIPTION OF THE DISCLOSURE

The technical solutions in the disclosure embodiments will be clearly and completely described below in conjunction with the accompanying drawings in the disclosure embodiments. Obviously, the described embodiments are only a part of the embodiments of the disclosure, and not all of the embodiments. All other embodiments obtained by those skilled in the art without creative effort based on the embodiments in the present disclosure fall within the scope of protection of the present disclosure.

“Embodiment” or “embodiments” used herein means a particular feature, structure or characteristic that may be included in at least one realization of the disclosure. In the description of the disclosure, it should be understood that the azimuth or positional relationship indicated by the terms “upper”, “lower”, “top” and “bottom” is based on the azimuth or positional relationship shown in the attached drawings, and is only for the convenience of describing the disclosure and simplifying the description, and does not indicate or imply that the referred device or element must have a specific orientation, be constructed and operated in a specific orientation, so it cannot be understood as a limitation of the disclosure. Furthermore, the terms “first” and “second” are used for descriptive purposes only and are not to be understood as indicating or implying relative importance or implicitly specifying the number of technical features indicated. Thus, a feature defined with the terms “first” and “second” may expressly or implicitly include one or more such features. Furthermore, the terms “first”, “second”, etc. are used to distinguish similar objects and need not be used to describe a particular order or sequence. It should be understood that the data so used may be interchanged, where appropriate, so that the embodiments of the disclosure described herein can be embodied in an order other than those illustrated or described herein.

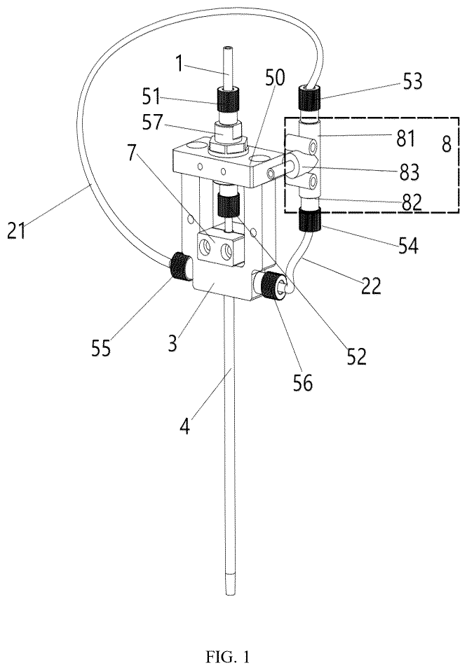

Reference is made to FIG. 1, FIG. 1 is a structural schematic diagram of an inner/outer wall cleaning mechanism for a pipetting needle provided by an embodiment of the disclosure, as shown in FIG. 1, the disclosure provides an inner/outer wall cleaning mechanism of a pipetting needle, and the inner/outer wall cleaning mechanism is used for cleaning a pipetting needle 4, comprising:

An inner wall cleaning pipe 1; the inner wall cleaning pipe 1 is connected at one end to the upper part of the pipetting needle 4 and at the other end to an injection device;

The present disclosure does not limit the connectivity model between the inner wall cleaning pipe and the pipetting needle, and can be flexibly set up according to the actual needs, optionally, one end of the inner wall cleaning pipe 1 can be directly extended to the upper part of the pipetting needle 4, or it can be connected to form a flow channel by a pipe joint, and then accessed to the upper part of the pipetting needle 4 by a pipe joint.

An outer wall cleaning pipe; the outer wall cleaning pipe is connected at one end to a liquid guide 3 and at the other end to the injection device;

The present disclosure does not limit the connection mode between the outer wall cleaning pipe and the injection device, which can be set up according to the actual needs, and exemplarily, the outer wall cleaning pipe and the injection device can be connected by a pipe connector, a pipe joint and other connection parts.

The liquid guide 3; liquid inlets 31 are arranged on both sides of the liquid guide 3, a liquid outlet 32 and an outer wall cleaning passageway hole 33 are arranged in the liquid guide 3, one end of the liquid inlet 31 is connected to the outer wall cleaning pipe at one end, the other end of the liquid inlet is connected to the end of the liquid outlet 32, and the other end of the liquid outlet 32 is connected to the outer wall cleaning passageway hole 33.

Wherein the liquid guide 3 is used to guide the flow direction of the cleaning liquid so that the cleaning liquid enters into the outer wall cleaning passageway hole 33 along the pre-set liquid inlet 31-liquid outlet 32, thereby cleaning the outer wall of the pipetting needle 4. The outer wall cleaning pipe is used to introduce the cleaning liquid into the liquid inlet 31, thereby cleaning the outer wall of the pipetting needle 4. Optionally, the liquid outlet 32 may be connected to any location on the outer wall cleaning passageway hole 33, or it may be connected to the top of the outer wall cleaning passageway hole 33, as the top of the outer wall cleaning passageway hole 33 is close to the top of the needle barrel of the pipetting needle 4, in order to prevent the cleaning liquid from overflowing to the inside of the needle barrel of the pipetting needle 4, resulting in secondary contamination, both sides of the grooved surface 61 are sealed, and the liquid outlet 32 may be connected to the bottom of the outer wall cleaning passageway hole 33. Preferably, the liquid outlet 32 may be connected to the middle of the outer wall cleaning passageway hole 33 to ensure a high flow rate and pressure of the cleaning liquid for cleaning the outer wall.

The present disclosure does not limit the number of outer wall cleaning pipes and liquid inlets 31 in the liquid guide 3, which can be determined according to the actual application, and the number of outer wall cleaning pipes is related to the number of the liquid inlets 31, exemplarily, the number of outer wall cleaning pipes can be 2 if the liquid guide 3 comprises 2 liquid inlets 31, and the number of outer wall cleaning pipes can be 3 if the liquid guide 3 comprises 3 liquid inlets.

The present disclosure provides an inner/outer wall cleaning mechanism for a pipette needle that cleans the inner wall of the pipette needle through an inner wall cleaning pipe and cleans the outer wall of the pipette needle through an outer wall cleaning pipe, thereby realizing comprehensive cleaning of the inner/outer wall of the pipette needle, and is capable of cleaning the outer wall of the pipette needle from a plurality of angles by providing a liquid inlet on both sides of the liquid guide, optimizing the cleaning effect of the pipette needle by connecting the outlet opening to the middle of the outer wall cleaning passageway hole. The flow rate and pressure of the cleaning liquid are increased, further enhancing the cleaning strength of the outer wall. Cleaning the pipetting needle by means of the inner/outer wall cleaning mechanism saves manpower, reduces the dependence on manual operation and the requirement for precision of manual operation, reduces the probability of cross-contamination of the pipetting needle, shortens the time interval for replacing the pipetting needle with a solution, and improves the productivity of the laboratory.

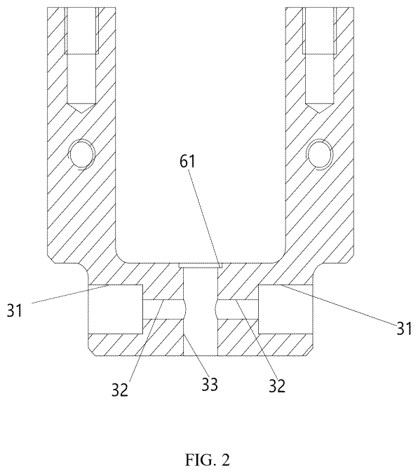

Reference is made to FIG. 2, FIG. 2 is a schematic diagram of a structure of a liquid guide model provided by an embodiment of the disclosure, as shown in FIG. 2. In some possible embodiments, the diameter of the liquid outlet 32 is smaller than the diameter of the liquid inlet 31.

When a certain flow rate of liquid flows into a narrow channel, the liquid flow rate increases, which has the effect of slit acceleration.

Optionally, the diameter of the liquid outlet 32 may also be equal to or larger than the diameter of the liquid inlet 31, and the liquid outlet 32 and the liquid inlet 31 together serve to direct the flow of the cleaning liquid.

In the present disclosure, the diameter of the liquid outlet is smaller than the diameter of the liquid inlet, so that the cleaning liquid is accelerated when it flows out of the outer wall cleaning channel hole through the liquid inlet, and the flow rate of the cleaning liquid is increased, so that two cleaning liquids form a high-speed spiral flow on the outer wall of the pipetting needle, and the cleaning force on the outer wall is improved; at the same time, the cleaning liquid flowing at a high speed can take away the solution droplets at the tip of the pipetting needle, and the cleaning effect on the pipetting needle is further improved.

Reference is made to FIG. 1, in some possible embodiments, the outer wall cleaning pipe is connected to the injection device via a pipe connector, the pipe connector comprising at least a liquid inlet pipe opening 83 and a cleaning pipe opening, the liquid inlet pipe opening 83 being connected to the injection device, and the cleaning pipe opening being connected to the outer wall cleaning pipe.

Optionally, the liquid inlet pipe opening 83 is used to introduce the cleaning liquid from the injection device into the pipe connector, and the cleaning pipe opening is used to transfer the cleaning liquid in the pipe connector into the outer wall cleaning pipe, thereby cleaning the outer wall of the pipetting needle 4.

Optionally, the number of cleaning pipe openings is at least one, and the number of pipe openings of the outer wall cleaning pipe can be set to at least three as desired.

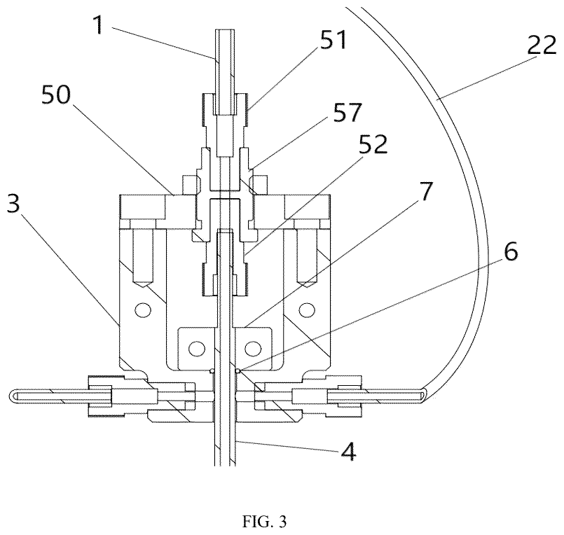

Reference is made to FIG. 3, FIG. 3 is a schematic diagram of a connection relationship of an outer wall cleaning pipe provided by an embodiment of the disclosure, as shown in FIG. 3. In some possible embodiments, the outer wall cleaning pipe comprises a first connection opening, a second connection opening and a third connection opening, the first connection opening being connected to a liquid inlet 31 on one side of the liquid guide 3, the second connection opening being connected to a liquid inlet 31 on the other side of the liquid guide 3 and the third connection opening being connected to the cleaning pipe opening.

Further, the outer wall cleaning pipe may be a one-piece molded pipe having three pipe openings, or a pipe assembly obtained by combining and connecting a plurality of double-perforated pipes through a tee connector, the double-perforated pipes being pipes having two pipe openings, and exemplarily, one end of a double-perforated pipe may be connected to the cleaning pipe opening, and the other end may be connected to two other double-perforated pipes through the tee connector, respectively, in order to obtain the outer wall in the form of a pipe assembly cleaning pipe, the two double-orifice pipes cleaning the outer wall of the pipetting needle 4 from each side.

The disclosure embodiment, by using a pipe having three pipe openings or a pipe assembly obtained by combining and connecting a plurality of double-perforated pipes, diverts the cleaning liquid flowing from the cleaning pipe opening into the outer wall cleaning pipe into two tributaries flowing to the liquid inlet mouths on both sides of the liquid guide respectively, rinsing the outer wall of the pipetting needle from two different angles, enhancing the coverage area of the rinsing, and enhancing the cleaning strength.

Reference is made to FIGS. 1 and 2, in some possible embodiments, the cleaning pipe opening comprises a first pipe opening 81 and a second pipe opening 82, the outer wall cleaning pipe comprising:

A first outer wall cleaning pipe 21, which is connected at one end to the liquid inlet 31 on the side of the liquid guide 3;

A second outer wall cleaning pipe 22, which is connected at one end to a liquid inlet 31 on the other side of the liquid guide 3;

The other end of the first outer wall cleaning pipe 21 is connected to the first pipe opening 81 and the other end of the second outer wall cleaning pipe 22 is connected to the second pipe opening 82.

Optionally, if the first outer wall cleaning pipe 21 and the second outer wall cleaning pipe 22 are both flexible pipes, the number of outer wall cleaning pipes corresponds to the number of liquid inlets 31 in the liquid guide 3. In order to carry out a multi-directional cleaning of the outer wall of the pipetting needle, the number of liquid inlets can be increased, e.g., when the number of liquid inlets 31 is 2, the number of outer wall cleaning pipes is correspondingly also 2.

Further, one end of the outer wall cleaning pipe is connected to the injection device for injecting the cleaning liquid, and when the outer wall cleaning pipe includes the first outer wall cleaning pipe 21 and the second outer wall cleaning pipe 22, they can be connected to the same injection device or to different injection devices, and it is possible to control a plurality of orientations of the outer wall cleaning pipes to clean the outer wall of the pipetting needle 4 at the same time, and it is also possible to control a plurality of orientations of the outer wall cleaning pipes to successively clean the outer wall of the pipetting needle 4. The outer wall of the pipetting needle 4 can be cleaned by controlling the outer wall cleaning pipes in a plurality of directions simultaneously, or the outer wall cleaning pipes in a plurality of directions can be cleaned sequentially.

Wherein, the injection device refers to a device that performs an injection operation of a liquid or a gas, exemplarily, the injection device may be a syringe pump, capable of controlling the speed and flow rate of the injection; the present disclosure does not make a limiting description of the injection device, and according to the actual need, the syringe pump may be a multi-channel syringe pump, a micro syringe pump, a programmable syringe pump, and the like.

Further, when the outer wall cleaning pipes are connected to the same injection device, they need to be connected by the pipe connector 8, the pipe connector 8 being a component for changing the direction of flow of the liquid, exemplarily, as shown in FIG. 1 the pipe connector 8 is a tee connector comprising a first pipe opening 81, a second pipe opening 82, and a liquid inlet pipe opening 83, and when the cleaning liquid flows from the liquid inlet pipe opening 83 into the pipe connector 8, the cleaning liquid is divided into two ways to flow to the first pipe opening 81, the second pipe opening 82 and to the first outer wall cleaning pipe 21 and the second outer wall cleaning pipe 22, respectively.

The disclosure embodiment, by providing an outer wall cleaning pipe, fully cleans the outer wall of the pipetting needle, improves the cleaning efficiency of the outer wall of the pipetting needle, enhances the cleaning effect of the outer wall, and, by connecting the first outer wall cleaning pipe and the second outer wall cleaning pipe to different injection devices, is able to carry out cleaning at different flow rates and with different intensities on the two sides of the pipetting needle, and is able to control the order of the cleaning, and enriches the pipetting needle cleaning program with The cleaning sequence can be controlled, which enriches the diversity and flexibility of pipette cleaning solutions.

Please continue to refer to FIGS. 1 and 3, as shown, in some possible embodiments, the inner/outer wall cleaning mechanism further comprises a first pipe joint 51, a second pipe joint 52 and a pipe joint connecting plate 50, one end of the first pipe joint 51 being connected to one end of the inner/outer wall cleaning pipe 1, the first pipe joint 51 and the second pipe joint 52 being fixedly connected by the pipe joint connecting plate 50, the first pipe joint 51 and the second pipe joint 52 forming a channel between them, one end of the second pipe joint 52 being connected to the upper part of the pipetting needle 4.

Optionally, the first pipe joint 51 and the second pipe joint 52 are fixedly connected by the pipe joint connecting plate 50 in a manner that may be a snap-fit, a plug-fit, a threaded connection, and the like. Exemplarily, the pipe joint connecting plate 50 comprises a snap joint 57, and the first pipe joint 51 and the second pipe joint 52 are respectively inserted into the snap joint 57, and are connected and fixed to the pipe joint connecting plate 50 by cooperating with a fastener such as a nut through the snap joint 57.

Optionally, for the inner wall cleaning pipe 1 or the outer wall cleaning pipe, both ends of each of the cleaning pipes are connected by pipe joints, wherein the upper part of the first pipe joint 51 can be connected to an injection device, and the cleaning solution is introduced from the first pipe joint 51, flows into the channel of the second pipe joint 52 via the inner wall cleaning pipe 1, and then flows into the inside of the pipetting needle 4 via the upper part of the pipetting needle 4, so that the inside of the pipetting needle is cleaned.

Further, in order to ensure more thorough cleaning of the interior of the pipetting needle 4, a flow-guide groove with a channel may be provided in the upper portion of the pipetting needle 4, with one end of the channel extending to the inner wall of the pipetting needle 4, to ensure that the cleaning fluid flows into the pipetting needle 4 and then can flow down evenly along the inner wall of the pipetting needle 4.

The disclosure embodiment fixes the inner wall cleaning pipe by setting the first pipe joint and the second pipe joint, so that the cleaning liquid can flow into the pipetting needle through the channel formed between the inner wall cleaning pipe and the pipe joint, thereby deeply cleaning the inner wall, improving the inner wall cleaning efficiency and cleaning effect, reducing the possibility of residual liquid in the inner wall, and improving the non-polluting nature of the experiment.

In some possible embodiments, the inner/outer wall cleaning mechanism further comprises a third pipe joint 53, a fourth pipe joint 54, a fifth pipe joint 55 and a sixth pipe joint 56, the third pipe joint 53 connecting the first outer wall cleaning pipe 21 and the first pipe opening 81, the fourth pipe joint 54 connecting the second outer wall cleaning pipe 22 and the second pipe opening 82, the fifth pipe joint 55 connecting the first outer wall cleaning pipe 21 and the liquid inlet 31 on one side of the liquid guide 3, the sixth pipe joint 56 connecting the second outer wall cleaning pipe 22 and the liquid inlet 31 on the other side of the liquid guide 3.

Further, in order to meet the needs of different cleaning solution flow rates, pipe joints with different inner diameters can also be used. The cleaning speed and strength are controlled by replacing the pipe joints with different inner diameters, and in addition, in order to adapt to different experimental environments and to adapt to the chemical properties of different solutions, pipe joints of different materials can be selected, and exemplarily, the material of the pipe joints can be a PFA material or the like, which will not be repeated herein.

The disclosure embodiment makes it easier to disassemble the pipes by providing pipe joints between the pipes, improves the convenience of maintenance of the inner/outer wall cleaning device thereby extending the service life of the device, and at the same time enhances the sealing of the cleaning fluid in the pipes, reduces the risk of cross-contamination, and ensures the cleanliness of the pipetting needle.

Reference is made to FIG. 3, in some possible embodiments, the inner/outer wall cleaning mechanism further comprises a fixing member 7, the fixing member 7 being socketed to the outer wall of the pipetting needle 4, the fixing member 7 being connected and fixed to an upper surface of the liquid guide 3, the upper surface being a surface of the liquid guide 3 in contact with the fixing member 7.

Wherein the fixing member 7 is used to fix the pipetting needle 4, as shown in the figure, the upper part of the pipetting needle 4 passes through the fixing member 7, the lower part of the pipetting needle 4 passes through the outer wall cleaning passageway hole 33 of the liquid guide 3, and the fixing member 7 fixes the pipetting needle 4 and the liquid guide 3 together.

The disclosure embodiment enhances the stability of the pipetting needle in the mechanism by fixing the pipetting needle and the liquid guide, so that the inner wall cleaning pipe can introduce the cleaning liquid into the inside of the barrel of the pipetting needle, avoiding the flow of the cleaning liquid into other parts of the body, and enhancing the accuracy of the location control of the pipetting needle cleaning, and improving the efficiency of the pipetting needle cleaning and the effect of the pipetting needle cleaning.

Reference is further made to FIGS. 2 and 3, in some possible embodiments, the inner/outer wall cleaning mechanism further comprises a sealing member 6, the sealing member 6 being provided on a grooved surface 61 of the liquid guide 3; wherein the grooved surface 61 is obtained by grooving the upper surface of the liquid guide 3, the upper surface being the surface of the liquid guide 3 near the top of the barrel of the pipetting needle 4.

It should be noted that the cleaning fluid flows in from the liquid inlet 31 on both sides of the liquid guide 3, and flows out to the outer wall cleaning passageway hole 33 via the liquid outlet 32, so as to clean the outer wall of the pipetting needle 4. At this time, the cleaning fluid flow rate is large and the impact force is strong, which may produce a strong impact when encountering the outer wall of the pipetting needle 4, resulting in the cleaning fluid in the outer wall cleaning passageway hole 33 splashing around. Since the top of the barrel of the pipetting needle 4 is close to the distance of the outer wall cleaning passageway hole 33, the cleaning fluid may splash to the top of the barrel of the pipetting needle 4. In order to avoid the top of the barrel of the pipetting needle 4 flowing into the cleaning fluid from the outer wall cleaning passageway hole 33, which may cause secondary contamination of the interior of the pipetting needle 4, the orifice of the outer wall cleaning passageway hole 33 near the top of the barrel of the pipetting needle 4 is sealed.

Further, as shown, a grooved surface 61 is provided on the upper surface of the liquid guide 3, and a sealing member 6 is provided in the grooved surface 61 to restrict the cleaning liquid in the outer wall cleaning passageway hole 33 below the sealing member 6. Optionally, grooving means machining the upper surface of the liquid guide 3 to obtain the grooved surface 61, wherein the sealing member may be an O-ring or the like.

The disclosure embodiment isolates the top of the barrel of the pipetting needle from the cleaning liquid used to clean the outer wall of the pipetting needle by providing a sealing member in the upper portion of the pipetting needle, avoids splattering of the cleaning liquid during cleaning of the outer wall of the pipetting needle into the inner/outer wall of the barrel of the pipetting needle, causing secondary pollution of the inner wall of the barrel, improves the safety and effectiveness of the cleaning of the pipetting needle, enhances the anti-pollution function of the pipetting needle for cleaning of the inner and outer wall, and enhances the pipetting needle's The independence of inner/outer wall cleaning.

In some possible embodiments, the other end of the inner wall cleaning pipe 1 and the other end of the outer wall cleaning pipe are connected to the injection device, or the other end of the inner wall cleaning pipe 1 and the other end of the outer wall cleaning pipe are connected to different injection devices.

Further, the inner/outer wall cleaning mechanism 12 may simultaneously clean the inner/outer wall by controlling the cleaning liquid to flow out of the inner wall cleaning pipe 1 and the outer wall cleaning pipe respectively through two syringe pumps, or it may be individually controlled to clean the inner wall or the outer wall, i.e., the inner wall cleaning pipe 1 and the outer wall cleaning pipe are connected to the same syringe pump, and the solenoid valves of a single syringe pump are only to be switched. And furthermore, the cleaning liquids in the inner wall cleaning pipe 1 and the outer wall cleaning pipe can be the same cleaning fluid or different cleaning fluids.

The disclosure embodiment realizes independent control of inner/outer wall cleaning by setting the connection between the inner wall cleaning pipe and the outer wall cleaning pipe and the injection device in a variety of ways, improves the flexibility of the control of inner/outer wall cleaning of the pipetting needle, and improves the efficiency of the cleaning of the inner/outer wall of the pipetting needle and the cleaning effect.

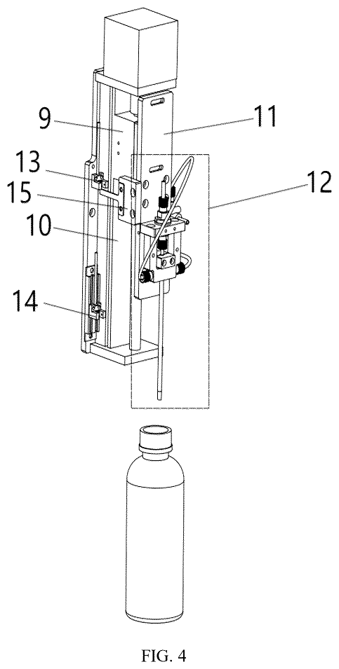

Reference is made to FIG. 4, FIG. 4 is a schematic diagram of a structure of a pipetting needle assembly provided by an embodiment of the present disclosure, as shown in FIG. 4, according to another aspect of the present disclosure, there is also provided a pipetting needle assembly having an inner/outer wall cleaning mechanism of a pipetting needle, the pipetting needle assembly comprising a sliding structure 9, a mobile module 10, a connecting structure 11, and an inner/outer wall cleaning mechanism, the inner/outer wall cleaning mechanism being connected to the connecting structure 11 fixedly connected, the connecting structure 11 being slidably connected to the mobile module 10 via the sliding structure 9.

It is to be noted that the inner/outer wall cleaning mechanism 12 is fixedly connected to a first surface of the connection mechanism 11, the inner/outer wall cleaning structure 12 is fixedly connected to the sliding structure 9 via a second surface of the connecting structure 11, the sliding structure 9 is slidably provided on a track of the mobile module 10, and the sliding structure 9 drives the inner/outer wall cleaning mechanism 12 to slide on the track of the mobile module 10, and exemplarily, the sliding structure 9 may be a sliding block.

Optionally, the first surface of the connecting structure 11 is a surface parallel to and away from the mobile module 10, and the second surface is a surface parallel to and proximate to the mobile module 10.

Optionally, the transmission mode of the mobile module 10 may be a slide screw transmission, a synchronous belt transmission, a rack and pinion transmission, etc. Exemplarily, as shown in FIG. 4, the mobile module 10 adopts a screw to cooperate with a linear slide to drive the sliding structure 9 to slide up and down, and furthermore, a waste liquid collection device is provided under the pipetting needle assembly for collecting the cleaning liquid that flows down after cleaning the inner/outer wall of the pipetting needle 4.

Further, for the cleaning of the inner/outer wall, the amount of cleaning liquid injected into the injection device and the injection speed can be set by the host computer to control the time of each cleaning.

The disclosure embodiment constitutes a pipetting needle assembly by combining a pipetting needle with an inner/outer wall cleaning mechanism, which can conveniently clean the inner/outer wall of the pipetting needle, realize special cleaning for special needles, save labor costs, thus shortening the interval time between the pipetting needle being put into production and use, and improve the cleaning efficiency, and by moving the pipetting needle assembly up and down along with the mobile module, so that the pipetting needle can be moved to a specific position according to the need to cooperate with other experimental equipment in the automation process, thus improving the degree of automation and productivity.

In some possible embodiments, the mobile module 10 is provided with a first sensor 13 and a second sensor 14, the connecting structure 11 is provided with a positioning sensor 15, the positioning sensor 15 is slidably provided between the first sensor 13 and the second sensor 14 through the connecting structure 11.

Optionally, the first sensor 13 and the second sensor 14 may be microwave sensors for detecting the position of the positioning sensor 15, the change in the position of the positioning sensor 15 being consistent with the change in the position of the inner/outer wall cleaning mechanism, and the position of the inner/outer wall cleaning mechanism being indirectly determined by detecting the position of the positioning sensor 15.

The disclosure embodiment detects in real time the location of the positioning sensor on the inner/outer wall cleaning mechanism by setting two sensors on the mobile module, thereby controlling the inner/outer wall cleaning mechanism to slide to the specified location through the sliding block structure, improving the accuracy of the control of the inner/outer wall cleaning mechanism, thereby improving the environmental cleanliness, and being able to closely cooperate with other automation equipment.

By implementing the technical solution of the present disclosure, at least the following beneficial effects can be obtained:
1. The present disclosure provides an inner/outer wall cleaning mechanism for a pipette needle that cleans the inner wall of the pipette needle through an inner wall cleaning pipe and cleans the outer wall of the pipette needle through an outer wall cleaning pipe, thereby realizing comprehensive cleaning of the inner/outer wall of the pipette needle, and is capable of cleaning the outer wall of the pipette needle from a plurality of angles by providing a liquid inlet on both sides of the liquid guide, optimizing the cleaning effect of the pipette needle by connecting the outlet opening to the middle of the outer wall cleaning passageway hole. The flow rate and pressure of the cleaning liquid are increased, further enhancing the cleaning strength of the outer wall. Cleaning the pipetting needle by means of the inner/outer wall cleaning mechanism saves manpower, reduces the dependence on manual operation and the requirement for precision of manual operation, reduces the probability of cross-contamination of the pipetting needle, shortens the time interval for replacing the pipetting needle with a solution, and improves the productivity of the laboratory.
2. In the disclosure embodiment, the diameter of the liquid outlet is set to be smaller than the diameter of the liquid inlet, so that the cleaning liquid is accelerated when it flows out of the outer wall cleaning channel hole through the liquid inlet, and the flow rate of the cleaning liquid is increased, so that two cleaning liquids form a high-speed spiral flow on the outer wall of the pipetting needle, and the cleaning force on the outer wall is improved; at the same time, the cleaning liquid flowing at a high speed can take away the solution droplets at the tip of the pipetting needle, and the cleaning effect on the pipetting needle is further improved.
3. The disclosure embodiment, by using a pipe having three pipe openings or a pipe assembly obtained by combining and connecting a plurality of double-perforated pipes, diverts the cleaning liquid flowing from the cleaning pipe opening into the outer wall cleaning pipe into two tributaries flowing to the liquid inlet mouths on both sides of the liquid guide respectively, rinsing the outer wall of the pipetting needle from two different angles, enhancing the coverage area of the rinsing, and enhancing the cleaning strength.
4. The disclosure embodiment, by providing an outer wall cleaning pipe, fully cleans the outer wall of the pipetting needle, improves the cleaning efficiency of the outer wall of the pipetting needle, enhances the cleaning effect of the outer wall, and, by connecting the first outer wall cleaning pipe and the second outer wall cleaning pipe to different injection devices, is able to carry out cleaning at different flow rates and with different intensities on the two sides of the pipetting needle, and is able to control the order of the cleaning, and enriches the pipetting needle cleaning program with The cleaning sequence can be controlled, which enriches the diversity and flexibility of pipette cleaning solutions.
5. The disclosure embodiment fixes the inner wall cleaning pipe by setting the first pipe joint and the second pipe joint, so that the cleaning liquid can flow into the pipetting needle through the channel formed between the inner wall cleaning pipe and the pipe joint, thereby deeply cleaning the inner wall, improving the inner wall cleaning efficiency and cleaning effect, reducing the possibility of residual liquid in the inner wall, and improving the non-polluting nature of the experiment.
6. The disclosure embodiment makes it easier to disassemble the pipes by providing pipe joints between the pipes, improves the convenience of maintenance of the inner/outer wall cleaning device thereby extending the service life of the device, and at the same time enhances the sealing of the cleaning fluid in the pipes, reduces the risk of cross-contamination, and ensures the cleanliness of the pipetting needle.
7. The disclosure embodiment enhances the stability of the pipetting needle in the mechanism by fixing the pipetting needle and the liquid guide, so that the inner wall cleaning pipe can introduce the cleaning liquid into the inside of the barrel of the pipetting needle, avoiding the flow of the cleaning liquid into other parts of the body, and enhancing the accuracy of the location control of the pipetting needle cleaning, and improving the efficiency of the pipetting needle cleaning and the effect of the pipetting needle cleaning.
8. The disclosure embodiment isolates the top of the barrel of the pipetting needle from the cleaning liquid used to clean the outer wall of the pipetting needle by providing a sealing member in the upper portion of the pipetting needle, avoids splattering of the cleaning liquid during cleaning of the outer wall of the pipetting needle into the inner/outer wall of the barrel of the pipetting needle, causing secondary pollution of the inner wall of the barrel, improves the safety and effectiveness of the cleaning of the pipetting needle, enhances the anti-pollution function of the pipetting needle for cleaning of the inner and outer wall, and enhances the pipetting needle's The independence of inner/outer wall cleaning.
9. The disclosure embodiment realizes independent control of inner/outer wall cleaning by setting the connection between the inner wall cleaning pipe and the outer wall cleaning pipe and the injection device in a variety of ways, improves the flexibility of the control of inner/outer wall cleaning of the pipetting needle, and improves the efficiency of the cleaning of the inner/outer wall of the pipetting needle and the cleaning effect.
10. The disclosure embodiment constitutes a pipetting needle assembly by combining a pipetting needle with an inner/outer wall cleaning mechanism, which can conveniently clean the inner/outer wall of the pipetting needle, realize special cleaning for special needles, save labor costs, thus shortening the interval time between the pipetting needle being put into production and use, and improve the cleaning efficiency, and by moving the pipetting needle assembly up and down along with the mobile module, so that the pipetting needle can be moved to a specific position according to the need to cooperate with other experimental equipment in the automation process, thus improving the degree of automation and productivity.
11. The disclosure embodiment detects in real time the location of the positioning sensor on the inner/outer wall cleaning mechanism by setting two sensors on the mobile module, thereby controlling the inner/outer wall cleaning mechanism to slide to the specified location through the sliding block structure, improving the accuracy of the control of the inner/outer wall cleaning mechanism, thereby improving the environmental cleanliness, and being able to closely cooperate with other automation equipment.

The above mentioned are only optional embodiments of the present disclosure, and are not intended to limit the present application, and any modifications, equivalent substitutions, improvements, etc. made within the spirit and principles of the present application shall be included in the scope of protection of the present application.

What is claimed is:

1. An inner/outer wall cleaning mechanism for a pipetting needle, the inner/outer wall cleaning mechanism for cleaning a pipetting needle, comprising:
an inner wall cleaning pipe; wherein the inner wall cleaning pipe is connected at one end to an upper part of the pipetting needle and at the other end to an injection device;
an outer wall cleaning pipe; wherein the outer wall cleaning pipe is connected at one end to a liquid guide and at the other end to the injection device; and
the liquid guide; wherein liquid inlets are arranged on both sides of the liquid guide, a liquid outlet and an outer wall cleaning passageway hole are arranged in the liquid guide, one end of the liquid inlet is connected to the outer wall cleaning pipe at one end, the other end of the liquid inlet is connected to the end of the liquid outlet, and the other end of the liquid outlet is connected to the outer wall cleaning passageway hole.

2. The mechanism according to claim 1, wherein a diameter of the liquid outlet is smaller than a diameter of the liquid inlet.

3. The mechanism according to claim 1, wherein the outer wall cleaning pipe is connected to the injection device via a pipe connector, the pipe connector comprising at least a liquid inlet pipe opening and a cleaning pipe opening, the liquid inlet pipe opening being connected to the injection device, and the cleaning pipe opening being connected to the outer wall cleaning pipe.

4. The mechanism according to claim 3, wherein the outer wall cleaning pipe comprises a first connection opening, a second connection opening and a third connection opening, the first connection opening being connected to a liquid inlet on one side of the liquid guide, the second connection opening being connected to a liquid inlet on the other side of the liquid guide, and the third connection opening being connected to the cleaning pipe opening.

5. The mechanism according to claim 3, wherein the cleaning pipe opening comprises a first pipe opening and a second pipe opening, and the outer wall cleaning pipe comprising:
a first outer wall cleaning pipe, which is connected at one end to the liquid inlet on the side of the liquid guide;
a second outer wall cleaning pipe, which is connected at one end to the liquid inlet on the other side of the liquid guide; and
the other end of the first outer wall cleaning pipe is connected to the first pipe opening, and the other end of the second outer wall cleaning pipe is connected to the second pipe opening.

6. The mechanism according to claim 1, wherein the inner/outer wall cleaning mechanism further comprises a first pipe joint, a second pipe joint and a pipe joint connecting plate, one end of the first pipe joint being connected to one end of the inner wall cleaning pipe, the first pipe joint and the second pipe joint are fixedly connected via the pipe joint connecting plate, a channel is formed between the first pipe joint and the second pipe joint, and one end of the second pipe joint is connected to the upper part of the pipetting needle.

7. The mechanism according to claim 5, wherein the inner/outer wall cleaning mechanism further comprises a third pipe joint, a fourth pipe joint, a fifth pipe joint and a sixth pipe joint, the third pipe joint being connected to the first outer wall cleaning pipe and the first pipe opening, the fourth pipe joint being connected to the second outer wall cleaning pipe and the second pipe opening, the fifth pipe joint is connected to the first outer wall cleaning pipe and the liquid inlet on one side of the liquid guide, and the sixth pipe joint is connected to the second outer wall cleaning pipe and the liquid inlet on the other side of the liquid guide.

8. The mechanism according to claim 4, wherein the inner/outer wall cleaning mechanism further comprises a fixing member which is arranged on the outer wall of the pipetting needle and which is connected and fixed to an upper surface of the liquid guide, the upper surface of the liquid guide being the surface of the liquid guide in contact with the fixing member.

9. The mechanism according to claim 1, wherein the inner/outer wall cleaning mechanism further comprises a sealing member, the sealing member being provided on a grooved surface of the liquid guide; and wherein the grooved surface is obtained by grooving the upper surface of the liquid guide, the upper surface being the upper surface of the liquid guide close to the pipetting needle surface at a top of a needle barrel of the pipetting needle.

10. The mechanism according to claim 1, wherein the other end of the inner wall cleaning pipe and the other end of the outer wall cleaning pipe are each connected to the same injection device, or the other end of the inner wall cleaning pipe and the other end of the outer wall cleaning pipe are each connected to different injection devices.

11. A pipetting needle assembly with an inner/outer wall cleaning mechanism for a pipetting needle, the pipetting needle assembly comprises a sliding structure, a mobile module, a connecting structure and the inner/outer wall cleaning mechanism as described in claim 1, the inner/outer wall cleaning mechanism being fixedly connected to the connecting structure, and the connecting structure being slidably connected to the mobile module via the sliding structure.

12. The assembly according to claim 11, wherein the mobile module is provided with a first sensor and a second sensor, the connecting structure is provided with a positioning sensor, and the positioning sensor is slidably arranged between the first sensor and the second sensor via the connecting structure.
